(19) United States
(12) Patent Application Publication
(10) Pub. No.: US 2015/0275066 A1
(43) Pub. Date: Oct. 1, 2015

(54) INFLATION FLUID FOR BOREHOLE PLUGS

(71) Applicant: WYONA LIMITED, Queensland (AU)

(72) Inventor: Michael John Martin, Queensland (AU)

(73) Assignee: TROUPERDALE PTY LTD., Queensland (AU)

(21) Appl. No.: 14/646,959

(22) PCT Filed: Nov. 27, 2013
(86) PCT No.: PCT/AU2013/001374

§ 371 Date: May 22, 2015

(30) Foreign Application Priority Data
Nov. 27, 2012 (AU) 2012905184

(51) Int. Cl. C09K 8/42; E21B 23/06; E21B 33/127

(52) U.S. Cl. CPC C09K 8/426; E21B 33/127; E21B 23/06

(57) ABSTRACT

An inflation fluid suitable for inflation of a borehole plug is provided which has distinct advantages in operation. The inflation fluid comprises water, dimethyl ether, propane and butane. Such a blend offers efficient inflation of the borehole plug and reduces the time to flammability of the expelled fluid compared with similar water/dimethyl ether only blends. The order in which the water, dimethyl ether, propane and butane are blended to form the inflation fluid has been surprisingly found to have a significant effect on the time to flammability of the subsequently expelled fluid.

### FIELD OF THE INVENTION

The present invention relates to an expansive inflation fluid and method of inflation of a borehole plug.

### BACKGROUND TO THE INVENTION

Any reference to background art herein is not to be construed as an admission that such art constitutes common general knowledge in Australia or elsewhere.

Expandable borehole plugs are generally employed to form a support or “deck” within an explosives borehole to support a column of explosive composition thereabove. Selective placement of one or more borehole plugs in a borehole enables selective concentration of explosive energy in one or more regions along the length of the borehole.

Inflatable borehole plugs usually comprise a sealed gas tight flexible bag containing a source of pressurized fluid which source, when actuated, has a time delay property to enable the flexible bag to be lowered into a borehole to a predetermined depth before expanding against the borehole wall to form a deck.

Typically the source of pressurized fluid comprises an aerosol canister with a conventional valve stem and a mechanical actuator which, when actuated, holds the valve in an open position to discharge the entire contents of the canister in a manner similar to insecticide “bombs” or other aerosol fumigants.

The aerosol canister may contain a quantity of a non-expansive liquid, such as water, and a quantity of an expansive propellant. Alternatively, the canister may contain only a standard, expandable fluid.

A dip tube or stem extends from the interior inlet port of the valve to open adjacent the base of the aerosol canister and, when actuated, water, if present, is discharged first and when substantially all of the water volume is discharged, the propellant gas is then discharged. In this manner, the water acts as a time delay fluid enabling the inflatable borehole plug to be lowered to a predetermined depth in a borehole before the propellant gas enters the flexible bag body of the plug to expand the body against the borehole wall.

The period of time delay can be as much as 5 minutes and is influenced by the volume of water in the aerosol can and/or the diameter of the discharge orifice in the valve and/or actuating cap. Expandable borehole plugs or modified forms thereof are described in Australian Patent 763474 and Australian Patent 779463, the disclosures of which are incorporated herein by reference.

Dimethyl ether (DME) and water are commonly employed as the expansive and non-expansive fluids, respectively, and are accepted as industry standards. However, the use of this combination presents a number of drawbacks. Firstly, before they can be made commercially available, pressurised canisters of inflation fluid for borehole plug must pass a test which assesses the length of time it takes for the expelled composition to ignite when exposed to a flame. This is colloquially referred to as the ‘enclosed drum test’ as it involves expelling the contents of a canister into a drum which is open at one end and which has a lit candle or other flame inside. The time taken for the fluids, or gases released therefrom, to ignite determines whether or not the canister will receive a flammable or non-flammable classification and thus whether its supply and distribution will be restricted or not.

In Australia the Australian Dangerous Goods Code regulates technical requirements for the land transport of dangerous goods across Australia. The latest version of this code (ADG7) has now made it more difficult to achieve a non-flammable rating for a canister for purposes such as inflation of borehole plugs. Specifically, to receive a non-flammable classification and thus to be able to transport the product freely throughout Australia, the canister must pass the enclosed drum test by not igniting for a period of at least 61 seconds. Similar tightening of the regulations and requirements regarding reduced flammability are common in many jurisdictions such as, for example, the United States.

An enclosed drum test on a commercial formulation of predominantly DME and water gave a result of 50 seconds, which is expected given the flammability of DME and the quantity required within the inflation fluid to inflate a borehole plug, and so would not receive a non-flammable categorisation thus greatly limiting the commercial potential of the product and reducing availability to customers.

A further drawback of DME and water mixes is that in cold climates the expelled inflation fluid does not always inflate the borehole plug sufficiently. This can result in failure of the plug and loss of time, man hours and explosives at cost to the mine operator. The failure rate in cold climes has been found to be unacceptably high. Even if the plug does ultimately hold it has been observed, again at lower temperatures, that complete inflation takes an excessive amount of time. This means a greater overall time is taken to charge each borehole with explosives which adds to the expense of an operation.

### OBJECT OF THE INVENTION

It is an aim of this invention to provide for an inflation fluid, an inflatable borehole plug containing same and a method of inflating a borehole plug which alleviate or overcome one or more of the above problems or otherwise provide the customer with an alternative commercial choice.

Other preferred objects of the present invention will become apparent from the following description.

### SUMMARY OF INVENTION

According to a first aspect of the invention, there is provided an inflation fluid in a compressed state for inflation of a borehole plug, the inflation fluid comprising water, dimethyl ether, propane and butane.

Preferably, the inflation fluid is a two-phase system with the gaseous propane and butane substantially separate from the liquid water and dimethyl ether mixture.

In one preferred embodiment the inflation fluid comprises, in % by weight amounts:

Water: 40-85%

DME: 5-35%

Propane/Butane: 5-35%.

In a further preferred embodiment the inflation fluid comprises, in % by weight amounts:

Water: 50-80%

DME: 10-30%

Propane/Butane: 7-30%.

In yet a further preferred embodiment the inflation fluid comprises, in % by weight amounts:

Water: 55-75%

DME: 13-25%

Propane/Butane: 8-25%.

In all cases the ratio of butane to propane within the inflation fluid is between 75 mol %:25 mol % to 55 mol %:45 mol %, preferably between 70 mol %:30 mol % to 60 mol %:40 mol %, more preferably about 65 mol %:35 mol %.

The propane butane mix may also contain quantities of not greater than 2 to 3 mol % of other alkanes including ethane and pentanes.

The inflation fluid may further comprise an alcohol in an amount of up to about 5% by weight, preferably up to about 3%, more preferably less than 2%.

Suitably, the alcohol is isopropyl alcohol (IPA).

The inflation fluid may further comprise propylene glycol and/or anti-corrosion agents in relatively small amounts.

The inflation fluid should have been generated by the addition of the propane and butane to the water prior to the addition of the dimethyl ether.

According to a second aspect of the invention, there is provided an inflatable borehole plug comprising:
(a) an inflatable fluid tight bag;
(b) a storage container located within the fluid tight bag, the storage container containing an inflation fluid in a compressed state and having an actuator for release of the inflation fluid;

wherein, the inflation fluid comprises water, dimethyl ether, propane and butane.

The inflatable fluid tight bag may be an inner bag located within a tough flexible outer bag.

The inflation fluid will have a composition as described for the first aspect.

In a preferred embodiment the storage container stem with an orifice through which the inflation fluid is dispensed, the orifice having a diameter of between 0.3 to 0.5 mm, preferably about 0.4 mm.

The inflation fluid should have been generated by the addition of the propane and butane to the water prior to the addition of the dimethyl ether.

According to a third aspect of the invention, there is provided a method of controlled inflation of an inflatable borehole plug including the steps of:
(a) providing an inflatable fluid tight bag having a storage container located therein, the storage container containing an inflation fluid in a compressed state and having an actuator for release of the inflation fluid into the fluid tight bag; and
(b) activating the actuator to thereby release the inflation fluid and bring about controlled inflation of the borehole plug;

wherein, the inflation fluid comprises water, dimethyl ether, propane and butane.

Suitably, the method is performed using the inflatable borehole plug as herein described.

The inflation fluid will have a composition as described for the first aspect.

The inflation fluid should have been generated by the addition of the propane and butane to the water prior to the addition of the dimethyl ether.

In a preferred embodiment the storage container stem with an orifice through which the inflation fluid is dispensed, the orifice having a diameter of between 0.3 to 0.5 mm, preferably about 0.4 mm.

The method may thus further include the step of passing the inflation fluid out of the storage container through an orifice having a diameter of between 0.3 to 0.5 mm, preferably about 0.4 mm.

According to a fourth aspect of the invention, there is provided a method of forming an inflation fluid in a compressed state for inflation of a borehole plug including the steps of (a) providing an amount of water in a pressurisable container; (b) adding a propane/butane mix to the water with the container in a pressurised state; and (c) adding dimethyl ether to the water/propane/butane mix to thereby form the inflation fluid.

The water, propane/butane blend and dimethyl ether may be present in the % by weight amounts as set out for the first aspect.

According to a fifth aspect of the invention, there is provided an inflation fluid in a compressed state for inflation of a borehole plug when prepared by the method of the fourth aspect.

### DETAILED DESCRIPTION OF THE DRAWINGS

In this patent specification, adjectives such as first and second, left and right, front and back, top and bottom, etc., are used solely to define one element or method step from another element or method step without necessarily requiring a specific relative position or sequence that is described by the adjectives. The terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Unless defined otherwise, all technical and scientific terms used herein have the same meaning as would be commonly understood by those of ordinary skill in the art to which this invention belongs.

The present invention is predicated, at least in part, on the surprising characteristics of an inflation fluid for inflation of a borehole plug, the inflation fluid comprising water, DME and a propane/butane blend as the major components in % by weight amounts. The present inventor has found that an inflation fluid having these components provides for an expansive fluid which, when expelled, will not ignite in an enclosed drum test prior to the 61 second limit to thereby attain a non-flammable classification.

Further, the inventor has surprisingly found that once the liquid/DME mix is expelled and the propane/butane blend then starts to come out of the canister it does so very rapidly and to a substantially complete extent. This provides advantages in rapid, strong and reliable borehole plug inflation. In contrast to a mostly DME/water inflation fluid, wherein the DME can partially remain in the water or, after expansion, can go back into the aqueous phase, the expansive fluid (being the DME in combination with the propane/butane mix) comes out of the non-expansive fluid (the water) and appears to stay separate in the gaseous phase. This means that the inflatable borehole plug maintains its internal pressure and hence its grip on the borehole walls thereby greatly lessening the chance of failure even in colder climes.

According to a first aspect of the invention, there is provided an inflation fluid in a compressed state for inflation of an inflatable borehole plug, the inflation fluid comprising water, dimethyl ether, propane and butane.

A storage container suitable for containing the inflation fluid of the present invention may be of the type that is known in the art of pressure cans that are commonly used to deliver materials by action of a propellant expanding through a nozzle. The container will have an actuator which may also be of a standard design for pressurised canisters and would be well known in the art.

Briefly, an activator, such as a press button, is provided on the actuator by which the storage container is able to be triggered in the field to deliver the inflation fluid into a borehole plug and inflate it. A variety of mechanisms might be used to seal or hold the expansive fluid in storage container until its release is to be effected. Release might be effected by a twist action seal, by the breaking of an elongate seal, by the depression of a valve activator, as will be known to those skilled in the art of storing gases under pressure in pressure cans and the like. Preferably, release is by activation of a one shot trigger. A one shot trigger is readily arranged by fitting a latch to the activation mechanism, operative to hold the activation mechanism in an activated state once it has been activated. This might be effected by a push button or lever that depresses the usual aerosol can valve outlet, the push button or lever being fitted with a locking lip, hook, latch or the like, as will be familiar to mechanical engineers. In this manner, once the actuator is activated it will dispense pressurised inflation fluid from the interior of the container until it has substantially all been expended.

When the activator is engaged the inflation fluid will rise up an internal dip tube within the container to be expelled from the top of this tube via an orifice. It is preferred that the diameter of this orifice is between 0.3 to 0.5 mm, between 0.37 to 0.43 mm, between 0.38 to 0.43 mm, between 0.39 to 0.43 mm, preferably about 0.4 mm. About 0.4 mm is considered to include 0.35, 0.36, 0.37, 0.38, 0.39, 0.40, 0.41, 0.42, 0.43, 0.44 and 0.45 mm diameter.

The storage container will contain a quantity of the inflation fluid sufficient to fully inflate an associated inflatable borehole plug such that it will engage with the walls of a borehole to provide an explosives decking means. The interior chamber of the container is not entirely filled with inflation fluid in liquid form, as would typically be the case with canisters of pressurised fluid, and so a head space is present above the liquid inflation fluid. Substantially all of the propane/butane mix and a portion of the DME will be present in the headspace as a vapour.

Preferably, the inflation fluid is a two-phase system with the gaseous propane and butane substantially separate from the liquid water and dissolved dimethyl ether mixture.

In one preferred embodiment the inflation fluid comprises, in % by weight amounts:

Water: 40-85%

DME: 5-35%

Propane/Butane: 5-35%.

In a further preferred embodiment the inflation fluid comprises, in % by weight amounts:

Water: 50-80%

DME: 10-30%

Propane/Butane: 7-30%.

In yet a further preferred embodiment the inflation fluid comprises, in % by weight amounts:

Water: 55-75%

DME: 13-25%

Propane/Butane: 8-25%.

In all cases the ratio of butane to propane within the inflation fluid is between 75 mol %:25 mol % to 55 mol %:45 mol %, preferably between 70 mol %:30 mol % to 60 mol %:40 mol %, more preferably about 65 mol %:35 mol %.

The propane butane mix may also contain quantities of not greater than 2 to 3 mol % of other alkanes including ethane and pentanes. The inflation fluid may further comprise an alcohol in an amount of up to about 5% by weight, preferably up to about 3%, more preferably less than 2%.

In one preferred embodiment, the propane/butane mix which is combined with the DME and water is a commercially available blend known as aerosol grade B60 which comprises approximately 35 mol % propane (±2 mol %) to 65 mol % butane (±2 mol %). Up to about 1.5 mol % of ethane and up to about 2.2 mol % of pantanes may also be present in the blend.

The alcohol may be any C1 to C6 straight chain or branched alcohol. Preferably, the alcohol is isopropyl alcohol (IPA).

The inflation fluid may further comprise propylene glycol and/or anti-corrosion agents in relatively small amounts.

While it will be appreciated that other component agents and additives may be present in the inflation fluid, in one particular form of the first aspect, the inflation fluid may consist essentially of water, dimethyl ether, propane and butane.

By “consist essentially of” is meant that at least 85%, preferably at least 90%, more preferably at least 95% of the inflation fluid is made up of the stated components and only those components.

It will be appreciated by a person of skill in the art that the exact composition of the inflation fluid will vary depending, particularly, on the diameter of the borehole to be charged. For example, for a 270 mm diameter borehole a useful composition has been found to be 120 g of water to 20-50 g B60 to 30-40 g of DME. Such a composition has the below relative % by weight amounts of the major components for each variation in composition:

(i) For 120 g water:40 g DME:50 g B60

Water: 57%

DME: 19%

B60: 24%.

(ii) For 120 g water:30 g DME:20 g B60

Water: 70%

DME: 18%

B60: 12%.

(iii) For 120 g water:30 g DME:40 g B60

Water: 63%

DME: 18%

B60: 12%.

(iv) For 120 g water:40 g DME:20 g B60

Water: 67%

DME: 22%

B60: 11%.

Further examples of blends which have successfully passed the enclosed drum test are shown in the table below wherein all quantities are quoted in gram amounts and the ‘blue’ valve refers to expulsion of the inflation fluid during the enclosed drum test occurring out of a 0.41 mm diameter orifice.

TABLE 1
Variations in formulations which have
passed the enclosed drum test.

| | | | |
|---|---|---|---|
| Water | B60 | DME | Valve colour |

WINTER FORMULATION

| | | | | |
|---|---|---|---|---|
| 270AK | 120 | 40 | 30 | BLUE |
| 250AK | 120 | 35 | 25 | BLUE |
| 230AK | 120 | 35 | 20 | BLUE |
| 200AK | 120 | 25 | 15 | BLUE |
| 165AK | 120 | 20 | 15 | BLUE |
| 127AK | 120 | 15 | 10 | BLUE |

SUMMER FORMULATION

| | | | | |
|---|---|---|---|---|
| 270AK | 120 | 35 | 30 | BLUE |
| 250AK | 120 | 30 | 25 | BLUE |
| 230AK | 120 | 30 | 20 | BLUE |
| 200AK | 120 | 25 | 15 | BLUE |
| 165AK | 120 | 20 | 15 | BLUE |
| 127AK | 120 | 15 | 10 | BLUE |

It can be seen that an increase in the amount of the B60 propane/butane blend is useful in cooler conditions to compensate for the somewhat lethargic coming out of the DME from the water. This winter formulation ensures full inflation of the borehole plug even in colder conditions which would present a serious challenge to prior art water/DME only formulations.

Enclosed drum flame tests were carried out for the above compositions as well as a control standard inflation fluid of mostly DME and water at standard laboratory temperature and humidity conditions. The DME and water prior art inflation fluid ignited after about 50 seconds which would therefore result in a flammable classification for the canister and contents thereby restricting the ability to transport the canisters, and borehole plugs containing same. For the compositions described above, which include the B60 propane/butane mix, the expanding fluid did not ignite until at least after 64 seconds and, in some instances, after 70 seconds. This demonstrates that the present inflation fluid composition is safer to use in the field and due to its non-flammable designation under relevant codes it can be more readily transported thereby improving distribution to reduce, costs and increase availability.

Since DME, propane and butane are all relatively flammable gases it is surprising that such a result is achieved by use of the present compositions. Although not wishing to be bound by any particular theory the inventor postulates that this may be due to the use of B60 allowing a reduction in the amount of DME used. The DME, in combination with the water, is first expelled as a liquid. When the relative amount of DME is reduced the time to combustion can likewise be reduced. Once all of the liquid water/DME has been expelled, with the accompanying time delay thereby caused, the B60 mix is then able to enter the dip tube which was previously submerged in the liquid mix and can then be expelled from the headspace. This delay in expulsion of the flammable B60 mix coupled with the lower relative amounts of DME expelled earlier in the process delay the time to combustion to beyond the set regulated limits without undue additional delay to the expansion process of the borehole plug.

The inflation fluid should have been generated by the addition of the propane and butane to the water prior to the addition of the dimethyl ether. It has been found that the order in which the B60 propane/butane blend and the DME are added to the water to form the inflation fluid has a very significant bearing on the time which the subsequently expelled fluid takes to ignite in the enclosed drum test.

This is an extremely surprising result as simple logic dictates that once all of the components are together in the pressurised canister then the order in which they were located there should not have any bearing on the subsequent expulsion and time to flammability of the expelled fluid. However, it has been found, in every case, that when the B60 is added to the water first followed by the dimethyl ether a significant delay in time to flammability is observed when compared with an inflation fluid which contains exactly the same relative amounts of each component but which was formed by the addition of DME to the water followed by the subsequent addition of the B60.

While not wishing to be bound by any particular theory it is postulated that when the B60 is added to the water first it, to a small extent, dissolves in the water and thereby reduces the solubility of the subsequently added DME in the water thereby minimising the amount expelled with the water prior to expulsion of the B60 component.

It could not have been predicted from a consideration of the individual components that such a difference in time to flammability would be observed based upon only the order in which the same components are mixed. While the inflation fluid containing DME which has been added to the water prior to the addition of the B60 is still useful with surprising properties in terms of efficient inflation of a borehole and reduced time to flammability, the embodiment wherein the B60 has been added to the water prior to addition of the DME is highly preferred.

According to a second aspect of the invention, there is provided an inflatable borehole plug comprising:
(a) an inflatable fluid tight bag;
(b) a storage container located within the fluid tight bag, the storage container containing an inflation fluid in a compressed state and having an actuator for release of the inflation fluid;

wherein, the inflation fluid comprises water, dimethyl ether, propane and butane.

The inflation fluid will have a composition as described for the first aspect. The order in which the components of B60 and DME were added to the water is also relevant here.

The inflatable borehole plug containing the storage container may be of a standard design and may be formed with an optional protective outer bag acting as a protective sheet material suited to engagement with the walls of a borehole, as protection for the inner inflatable fluid tight bag, particularly as it is lowered into place in a borehole. The storage container is encapsulated within the inner bag. The outer protective bag might simply be a facing sheet or sheets. Ideally, the outer protective sheet material is formed as an outer enclosing bag to protect the inner fluid tight bag.

The outer bag may be constructed from one sheet of material and stitched, adhered, heat sealed or otherwise affixed along a seam. The material may be a tough puncture resistant material such as a woven polypropylene fabric. Other suitable materials may include polymeric films; knitted, woven or non-woven fabrics of polymeric materials such as polyolefins, polyesters, polyamides and polyurethanes; glass fibre, carbon fibre, KEVLAR™ or like high tensile fibres; natural fibres such as cotton, jute, hemp and the like or mixtures thereof. Preferably, the outer bag is made from a high tensile polypropylene or similar polymeric material and additionally is provided with an anti-static coating.

The inner fluid tight bag may be constructed in a similar manner as described for the outer bag and may be made from a waterproof material. It may be formed by a heat welding process from a polyethylene, polypropylene, nylon film or a co-extrusion such as nylon/surlyn or polyethylene/nylon/polyethylene or may be manufactured from a range of materials including a seam welded bag fabricated from a laminate of films of Nylon or Nylon copolymers with an m—LLDPE sealant film.

Preferably, the inner bag is formed from PET (polyethylene terephthalate) film alone or in coextrusion or laminate with one or more other polymeric materials. One preferred material for the construction of the inner bag is barrier film material employed in the food industry. This is a well known coextruded moisture and air resistant polymer material.

The outer bag may be provided with one or more tags, adapted with an eyelet or like means, by which the inflatable borehole plug might be suspended, in the chosen orientation, during lowering into boreholes.

In a preferred embodiment the storage container is provided with a dip tube or stem which is continuous with an orifice through which the inflation fluid is dispensed, the orifice having a diameter of between 0.3 to 0.5 mm, between 0.3 to 0.5 mm, between 0.37 to 0.43 mm, between 0.38 to 0.43 mm, between 0.39 to 0.43 mm, preferably about 0.4 mm. About 0.4 mm is considered to include 0.35, 0.36, 0.37, 0.38, 0.39, 0.40, 0.41, 0.42, 0.43, 0.44 and 0.45 mm diameter.

The choice of the size of orifice is not just to dispense fluid at a particular rate. It has been found by the inventor that an orifice size of about 0.40 mm, specifically of 0.41 mm, provides distinct and surprising advantages in operation. During enclosed drum flame tests it was found that use of a storage container having the dispensing orifice of 0.41 mm initially expelled the inflation fluid in what appeared to be a cohesive or string-like form. After this phase of the fluid was dispensed the B60 blend then came out of the container extremely rapidly. In field trials this action caused a useful delay in expansion of the borehole plug followed by a period of very rapid and strong expansion. It appears as though this particular size of orifice is particularly suited to the inflation fluid composition and in the enclosed drum test trials added up to 10 seconds to the time taken to ignition. This was not attributable purely to a reduction in orifice size compared to other trials.

According to a third aspect of the invention, there is provided a method of controlled inflation of an inflatable borehole plug including the steps of:
(a) providing an inflatable fluid tight bag having a storage container located therein, the storage container containing an inflation fluid in a compressed state and having an actuator for release of the inflation fluid into the fluid tight bag; and
(b) activating the actuator to thereby release the inflation fluid and bring about controlled inflation of the borehole plug;

wherein, the inflation fluid comprises water, dimethyl ether, propane and butane.

Suitably, the method is performed using the inflatable borehole plug as herein described.

The inflation fluid will have a composition as described for the first aspect.

The compositions described in detail above were employed to inflate a borehole plug within a borehole. It was found, in cool weather, that the plug would grip the walls of the borehole at around 60 seconds for a 270 mm diameter hole. Once the bag grips the user can then let go of the rope from which the bag is suspended and can move on to load the next hole. This is a substantial improvement from the standard DME/water inflation fluids which took close to 2 minutes to achieve the same grip on the borehole walls. This means a substantial amount of man hours is wasted in just waiting for full inflation.

Further, when commercially available plugs employing a DME/water mix were tested it was found that even though they claimed to expand to ‘ready to load’ levels within 60 seconds it was found that the borehole plug would actually grip the walls of the borehole in about 60 seconds but only relatively loosely so and with creases in the plug causing gaps between the outer surface of the plug and the walls through which explosive could be lost. The present inflation fluid overcomes this problem in that, once the propane/butane blend starts to be expelled it comes very quickly and powerfully such that within seconds the borehole plug is expanded to its ready to load limit. This allows for more immediate and safer loading of explosives onto the borehole plug decking system. Importantly, the prior art plugs with gaps between the outer surface of the plug and the borehole wall not only allow explosive to escape into any stagnant or dynamic water below but also allow the corresponding ingress of water into the explosive composition being loaded onto the plug. This can result in an increase in fume which is highly undesirable for environmental reasons. The present inflation fluid in combination with a borehole plug results in such immediate and then sustained internal pressure within the borehole plug that gaps between the outer surface of the plug and the borehole walls are substantially eliminated thus keeping the explosives drier and ensuring no further contribution to existing fume generated by the explosion.

It will therefore be appreciated that the present inflation fluid compositions provide dual advantages in that the propane/butane comes out of the inflation fluid contained in the canister reliably and relatively quickly compared to DME alone while at the same time not generating an ignitable environment until after the time delay required by the regulations. Thus a safer, more reliable inflation fluid is provided which is also more environmentally friendly.

As was discussed above, in a preferred embodiment the storage container is provided with a dip tube or stem with an orifice through which the inflation fluid is dispensed, the orifice having a diameter of between 0.3 to 0.5 mm, between 0.37 to 0.43 mm, between 0.38 to 0.43 mm, between 0.39 to 0.43 mm, preferably about 0.4 mm. The method may thus further include the step of passing the inflation fluid out of the storage container through an orifice having a diameter of between 0.3 to 0.5 mm, preferably about 0.4 mm. This provides an advantageous delay in time to ignition in an enclosed drum test and, in operational use of the borehole plugs, aids in achieving an optimal inflation time for the borehole plug. It is postulated that this dimension of orifice impacts upon the physical characteristics of the fluid as it is forced through the orifice and generates a viscosity of composition such that an appropriate delay is created in the expandable fluid escaping from the aqueous phase.

The method of the third aspect may also include the step, prior to step (a), of forming the inflation fluid by adding propane and butane to water in a pressurised environment and subsequently adding dimethyl ether. As discussed previously this order of addition provides distinct advantages in operation.

According to a fourth aspect of the invention, there is provided a method of forming an inflation fluid in a compressed state for inflation of a borehole plug including the steps of (a) providing an amount of water in a pressurisable container; (b) adding a propane/butane mix to the water with the container in a pressurised state; and (c) adding dimethyl ether to the water/propane/butane mix to thereby form the inflation fluid.

The water, propane/butane blend and dimethyl ether may be present in the % by weight amounts as set out for the first aspect.

The borehole plug and other components of the invention are as described for any one of the preceding aspects.

According to a fifth aspect of the invention; there is provided an inflation fluid in a compressed state for inflation of a borehole plug when prepared by the method of the fourth aspect.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

What is claimed is:

1. An inflation fluid in a compressed state for inflation of an inflatable borehole plug, the inflation fluid comprising water, dimethyl ether, propane and butane.

2. The inflation fluid of claim 1 wherein the inflation fluid comprises, in % by weight amounts:
Water: 40-85%
DME: 5-35%
Propane/Butane: 5-35%.

3. The inflation fluid of claim 2 wherein the inflation fluid comprises, in % by weight amounts:
Water: 50-80%
DME: 10-30%
Propane/Butane: 7-30%.

4. The inflation fluid of claim 3 wherein the inflation fluid comprises, in % by weight amounts:
Water: 55-75%
DME: 13-25%
Propane/Butane: 8-25%.

5. The inflation fluid of claim 1 wherein the inflation fluid is a two-phase system with the gaseous propane and butane in a separate phase to the liquid water and dimethyl ether phase.

6. The inflation fluid of claim 1 wherein the ratio of butane to propane within the inflation fluid is between 75 mol %:25 mol % to 55 mol %:45 mol %.

7. The inflation fluid of claim 6 wherein the ratio of butane to propane within the inflation fluid is between 70 mol %:30 mol % to 60 mol %:40 mol %.

8. The inflation fluid of claim 1 wherein the inflation fluid comprises quantities of not greater than 3 mol % of other alkanes.

9. The inflation fluid of claim 1 wherein the inflation fluid comprises an alcohol in an amount of up to about 3 wt %.

10. The inflation fluid of claim 9 wherein the alcohol is isopropyl alcohol.

11. The inflation fluid of claim 1 wherein the inflation fluid consists essentially of water, dimethyl ether, propane and butane.

12. The inflation fluid of claim 1 wherein the inflation fluid is formed by the addition of the propane and butane to the water prior to the addition of the dimethyl ether.

13. An inflatable borehole plug comprising:
(a) an inflatable fluid tight bag;
(b) a storage container located within the fluid tight bag, the storage container containing an inflation fluid in a compressed state and having an actuator for release of the inflation fluid;
wherein, the inflation fluid comprises water, dimethyl ether, propane and butane.

14. The inflatable borehole plug of claim 13 wherein the inflatable fluid tight bag comprises an inner bag located within a tough flexible outer bag.

15. The inflatable borehole plug of claim 13 wherein the storage container comprises a stem which is continuous with an orifice through which the inflation fluid is dispensed, the orifice having a diameter of between 0.38 to 0.43 mm.

16. The inflatable borehole plug of claim 13 wherein the inflation fluid has a composition as defined in any one of claim 1 to claim 12.

17. A method of controlled inflation of an inflatable borehole plug including the steps of:
(a) providing an inflatable fluid tight bag having a storage container located therein, the storage container containing an inflation fluid in a compressed state and having an actuator for release of the inflation fluid into the fluid tight bag; and
(b) activating the actuator to thereby release the inflation fluid and bring about controlled inflation of the borehole plug;
wherein, the inflation fluid comprises water, dimethyl ether, propane and butane.

18. The method of claim 17 wherein step (a) further comprises the steps of (i) providing an amount of water in the storage container; (ii) adding a propane/butane mix to the water with the storage container in a pressurised state; and (iii) adding dimethyl ether to the water/propane/butane mix to thereby form the inflation fluid in a compressed state within the storage container.

19. The method of claim 17 wherein the inflation fluid has a composition as defined in any one of claim 1 to claim 12.

20. The method of claim 17 further including the step of expelling the inflation fluid out of the storage container through an orifice having a diameter of between 0.38 to 0.43 mm.

21-23. (canceled)
